(19) United States
(12) Patent Application Publication
(10) Pub. No.: US 2005/0204327 A1
(43) Pub. Date: Sep. 15, 2005

(54) Layout data verification method, mask pattern verification method and circuit operation verification method

(75) Inventors: Kiyohito Mukai, Kyoto (JP); Mitsumi Itou, Kyoto (JP); Ritsuko Ozoe, Osaka (JP); Tatsuo Ohashi, Shiga (JP); Hiroyuki Tsujikawa, Shiga (JP)

Correspondence Address: Jack Q. Lever, Jr.;McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 11/076,939

(22) Filed: Mar. 11, 2005

(30) Foreign Application Priority Data
Mar. 11, 2004 (JP) 2004-069585

(51) Int. Cl. G06F 17/50

(52) U.S. Cl. 716/19; 716/21

(57) ABSTRACT

In the verification method of the present invention, a defect that is to cause a problem in fabrication is extracted from a mask pattern. The mask pattern is one obtained by deforming a mask pattern of a photomask used in a photolithography process so as to provide a transferred image close to a desired design pattern. The verification method includes the steps of: determining the exposure dose in the photolithography process; simulating the photolithography process on a computer based on the determined exposure dose; checking whether or not the desired design pattern has been obtained; and locating a fault point and outputting the result.

### CROSS-REFERENCE TO RELATED APPLICATIONS

This application claims priority under 35 U.S.C. §119 on Patent Application No. 2004-69585 filed in Japan on Mar. 11, 2004, the entire contents of which are hereby incorporated by reference.

### BACKGROUND OF THE INVENTION

The present invention relates to a method for forming a mask pattern used for fabrication of semiconductor integrated circuits with high accuracy relative to a layout pattern as design values for the semiconductor integrated circuits.

In conventional mask pattern correction methods, corrected are a defocus occurring in an exposure process due to a difference in the height of an underlying layer and a dimension error occurring due to the proximity effect of a corrected pattern (Japanese Laid-Open Patent Publication No. 2002-333701 (page 3, paragraph 0016, FIG. 1), for example).

In other methods, correction using optical simulation results of layout design pattern data is adopted (Japanese Laid-Open Patent Publication No. 2002-174890 (page 2, paragraph 0008, FIG. 1), for example).

In the prior art technologies, with the aim of replicating a layout pattern as faithfully as possible, attention is focused on correction technology for correcting a mask pattern. The correction technology is known to include an error due to its theoretical limit. However, no verification has yet been established for circuit operation associated with deformation of a layout pattern due to this error. For example, when the absolute value of a fabrication variation is ±5 nm, the error is ±1.43% in the case of a minimum feature size of 350 mm, but it is ±5% in the case of a minimum feature size of 100 nm. In the latter case, therefore, the relative variation increases. No verification has conventionally been allowed for whether or not this potential variation error is permissible in the circuit design.

A problem that will occur in the future with achievement of a finer fabrication process and a potential problem that may occur in the present situation cannot be verified even based on layout data as long as simulation is made within the normal fabrication variation range. For example, although no problem occurs in fabrication in the case of a minimum feature size of 350 nm, a problem may occur in the case of a minimum feature size of 250 nm. To find out this problem under the fabrication technology for the minimum feature size of 350 mm, layout data for the minimum feature size of 350 nm may be scaled down to 71%, and fabrication may be made under the fabrication technology for the minimum feature size 350 nm. A problem that may possibly occur in the case of a minimum feature size of 250 nm can then be detected. The problem detected in the above manner is found to be a potential point of problem (point having the possibility of becoming a problem and coming to the surface in the future) because this indicates that the fabrication technology has no allowance at this point of problem even in the case of a minimum feature size of 350 nm.

In prediction of the yield in fabrication of semiconductor integrated circuits, the predicted value obtained based on layout data is different from the actual yield value because no consideration is given to the finished shape of a circuit pattern on a silicon wafer. The predicted value therefore includes an error. For example, a layout pattern formed on a silicon wafer is susceptible to the exposure dose within the range of a fabrication variation, defocus and steps computed from the layout pattern. The resultant layout pattern includes portions locally heavy or thin sporadically compared with the original layout pattern. Therefore, the sensitivity to an open circuit (cutting of the pattern) and a short circuit (contacting of adjacent lines of the pattern) tends to be low in the prediction of the yield of the semiconductor integrated circuits.

### SUMMARY OF THE INVENTION

The method of the present invention includes the steps of: simulating deformation of a layout pattern to be formed on a silicon wafer; extracting a circuit configuration formed on the silicon wafer from the deformed layout pattern; and simulating operation of the extracted circuit, whereby the degree of deformation of the layout pattern is computed based on the exposure dose within the range of a fabrication variation, defocus and steps computed from the layout pattern, a circuit configuration is extracted from the deformed layout pattern, and the resultant circuit is simulated, to thereby verify an effect of the deformation of the layout pattern on the circuit operation.

Alternatively, the method of the present invention includes the steps of: shrinking a layout pattern at a given rate; and simulating deformation of the shrunk layout pattern to be formed on a silicon wafer, whereby the degree of deformation of the layout pattern is computed based on the exposure dose within the range of a fabrication variation, defocus and steps computed from the layout pattern, to thereby verify an effect of the deformation of the shrunk layout pattern on the circuit operation.

Alternatively, the method of the present invention includes the steps of: simulating deformation of a layout pattern to be formed on a silicon wafer; and simulating an irregular problem occurring in a fabrication process, whereby the degree of deformation of the layout pattern is computed based on the exposure dose within the range of a fabrication variation, defocus and steps computed from the layout pattern, and degradation in yield due to an irregular problem in a fabrication process is detected, to thereby verify an effect of the deformation of the layout pattern on the circuit operation.

According to the present invention, a problem in circuit operation due to deformation of a layout pattern to be formed on a wafer can be detected. Thus, not the entire mask pattern, but only a portion of the mask pattern that is to cause a problem in circuit operation can be properly corrected. If such correction is not allowed, it is possible to return to circuit design and change the circuit configuration to enable normal operation.

Also, by shrinking a layout pattern at a given rate, prior examination can be made on a problem that will occur in design of next-generation semiconductor integrated circuits. In addition, a currently potential defective portion can be verified.

Moreover, by computing the yield based on deformation of a layout pattern to be formed on a wafer, the actual yield can be computed accurately, and thus proper correction can be made for a portion of a mask pattern that is to cause a problem. If such correction is not allowed, it is possible to return to layout design and change the layout pattern to enable normal operation.

The layout data verification method, the mask pattern correction method and the circuit operation verification method of the present invention include a photolithography simulation step, a silicon wafer step simulation step, a circuit information extraction step and a yield calculation step. These methods are useful for verification of a mask pattern and other uses. Using the verification results, also, these methods are applicable to prediction of the yield in fabrication of semiconductor integrated circuits and other uses. They are also applicable to detection of a potential problem factor.

### BRIEF DESCRIPTION OF THE DRAWINGS

FIG. 1 is a flowchart showing a procedure of a mask pattern verification method of Embodiment 1 of the present invention.

FIG. 2 is a flowchart showing a procedure of processing performed in a silicon wafer surface step simulation step shown in FIG. 1.

FIG. 3 is a view showing an example of a pattern having a high possibility of a short circuit.

FIG. 4 is a view showing an example of a pattern having a high possibility of a break.

FIG. 5 is a flowchart showing a procedure of a circuit information extraction method of Embodiment 2 of the present invention.

FIG. 6 is a flowchart showing a procedure of processing performed in an exposure dose determination step shown in FIG. 5.

FIG. 7 is a flowchart showing a procedure of processing performed in a photolithography simulation step shown in FIG. 5.

FIG. 8 is a flowchart showing a procedure of processing performed in a circuit information extraction step shown in FIG. 5.

FIGS. 9A, 9B and 9C are diagrammatic views demonstrating simplification of a layout pattern in the circuit information extraction step.

FIG. 10 is a flowchart showing a procedure of a mask pattern verification method of Embodiment 3 of the present invention.

FIGS. 11A and 11B are views for demonstrating a critical area.

FIG. 12 is a flowchart showing a procedure of a circuit design verification method of Embodiment 4 of the present invention.

FIG. 13 is a flowchart showing a procedure of processing performed in a layout pattern uniform shrink step shown in FIG. 12.

FIG. 14 is a graph showing the number of chips obtainable on a silicon wafer, the predicted yield of chips and the number of conforming chips obtainable on a silicon wafer, with respect to the layout pattern uniform shrink rate.

### DESCRIPTION OF THE PREFERRED EMBODIMENTS

Hereinafter, preferred embodiments of the present invention will be described with reference to the accompanying drawings.

### Embodiment 1

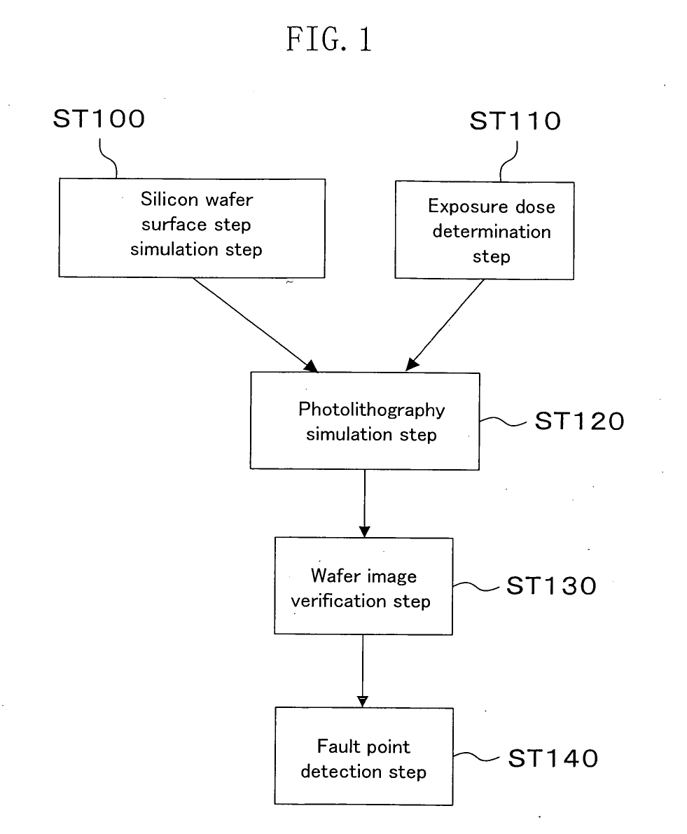

FIG. 1 is a flowchart showing a procedure of a mask pattern verification method of Embodiment 1 of the present invention. This verification method includes a silicon wafer surface step simulation step ST100, an exposure dose determination step ST110, a photolithography simulation step ST120, a wafer image verification step ST130, and a fault point detection step ST140. Hereinafter, these steps will be described specifically.

<Silicon Wafer Surface Step Simulation Step ST100>

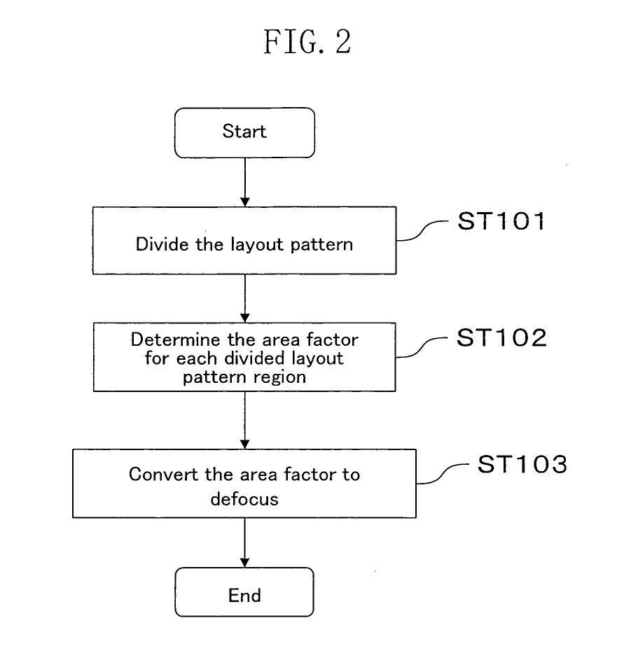

FIG. 2 shows a flow of processing performed in the silicon wafer surface step simulation step ST100.

First, the entire mask pattern is divided into regions in a grid shape (ST101). In this region division, each of the divided mask pattern regions is arranged to overlap its adjacent mask pattern regions by a given amount so that in photolithography simulation to follow for each layer of each of the mask pattern regions, a layout pattern is obtained as a result of simulation performed correctly even to the boundaries of each region.

The area factor of each layer is then calculated for each layout pattern region (ST102). The area factor of each layer is multiplied by a coefficient related to the height of the layer, to obtain the height of each layer of each layout pattern region, and then the height of a silicon wafer in each photolithography process can be obtained as the sum of the heights of all layers.

The difference (defocus) of the resultant height from the focus setting in the photolithography simulation is then determined as the silicon wafer surface step (ST103).

<Exposure Dose Determination Step ST110>

In the exposure dose determination step ST110, the step width is determined according to the required analysis accuracy within the range of a variation in exposure dose arising in the fabrication process in fabrication of semiconductor integrated circuits, and the exposure dose is determined to be changed so that the range of the variation from its lower to upper limits is scanned with the step width.

<Photolithography Simulation Step ST120>

In the photolithography simulation step ST120, simulation is performed to replicate the photolithography process in fabrication of semiconductor integrated circuits on a computer based on the defocus value determined in the silicon wafer surface step simulation step ST100 and the exposure dose for each step width determined in the exposure dose determination step ST110. As a result of the simulation, a layout pattern shape (wafer image) formed on a silicon wafer is obtained.

<Wafer Image Verification Step ST130>

In the wafer image verification step ST130, pattern comparison is made between the layout pattern obtained as a result of the photolithography simulation and the design layout pattern.

<Fault Point Detection Step ST140>

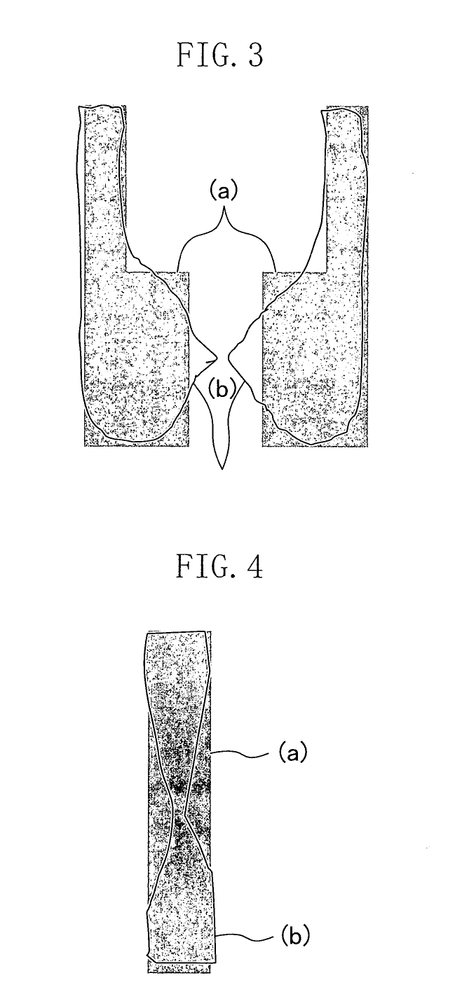

In the final fault point detection step ST140, when a short circuit or a break is found in the wafer image verification step ST130, such a point is naturally detected as a fault point. In addition, an allowance is set so that a point having a high possibility of causing a short circuit or a break although not yet causing such a trouble (for example, solid-line patterns (b) in FIGS. 3 and 4) can also be detected as a fault point, and any point exceeding the allowance is regarded as an error as a fault point. FIG. 3 shows an example of pattern having a high possibility of a short circuit, and FIG. 4 shows an example of pattern having a high possibility of a break. In FIGS. 3 and 4, the reference code (a) denotes a design layout pattern, and (b) denotes a layout pattern obtained as a result of the photolithography simulation.

### Embodiment 2

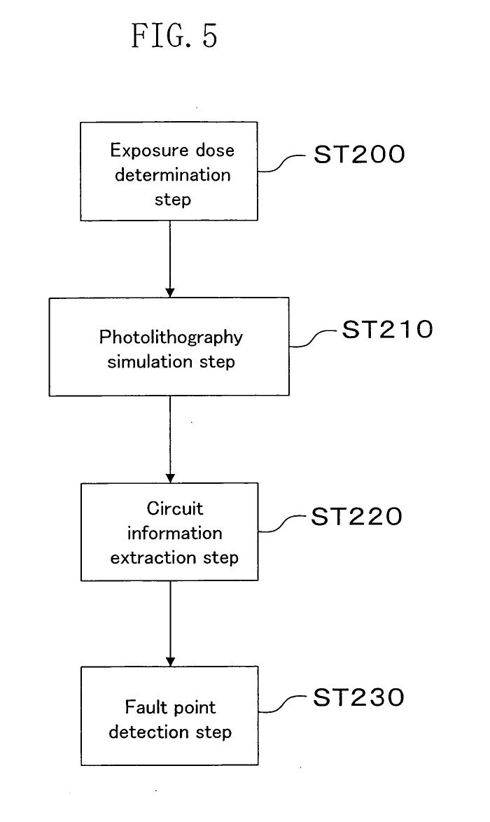

FIG. 5 is a flowchart showing a procedure of a circuit information extraction method of Embodiment 2 of the present invention. This verification method includes an exposure dose determination step ST200, a photolithography simulation step ST210, a circuit information extraction step ST220, and a fault point detection step ST230. Hereinafter, these steps will be described specifically.

<Exposure Dose Determination Step ST200>

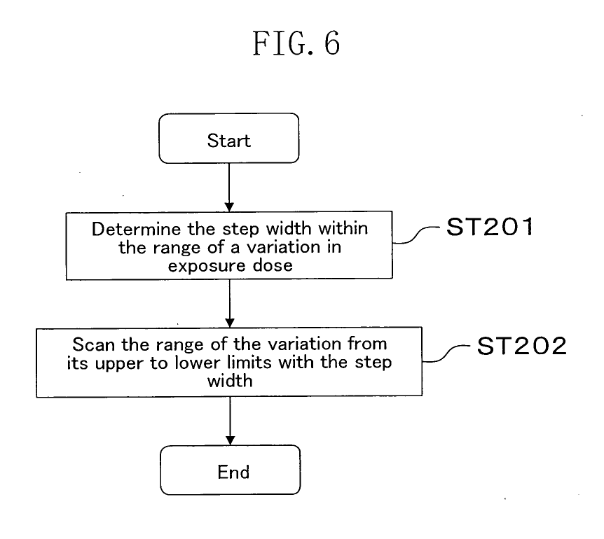

FIG. 6 shows a flow of processing performed in the exposure dose determination step ST200. In the exposure dose determination step ST200, the step width is determined according to the required analysis accuracy within the range of a variation in exposure dose arising in the fabrication process in fabrication of semiconductor integrated circuits (ST201), and the exposure dose is determined to be changed so that the range of the variation from its lower to upper limits is scanned with the step width (ST202).

<Photolithography Simulation Step ST210>

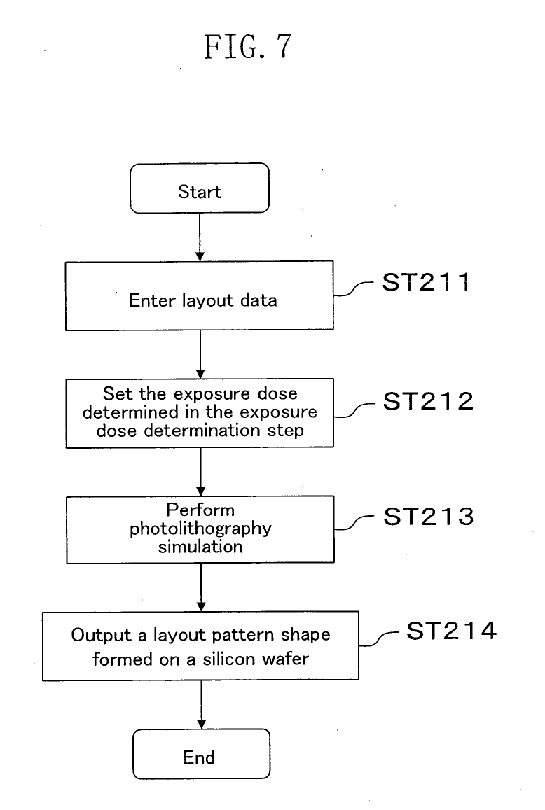

FIG. 7 shows a flow of processing performed in the photolithography simulation step ST210. In the photolithography simulation step ST210, simulation is performed to replicate the photolithography process in fabrication of semiconductor integrated circuits on a computer based on the exposure dose for each step width determined in the exposure dose determination step ST200 (ST211 to ST213). As a result of the simulation, a layout pattern shape formed on a silicon wafer is obtained (ST214).

<Circuit Information Extraction Step ST220>

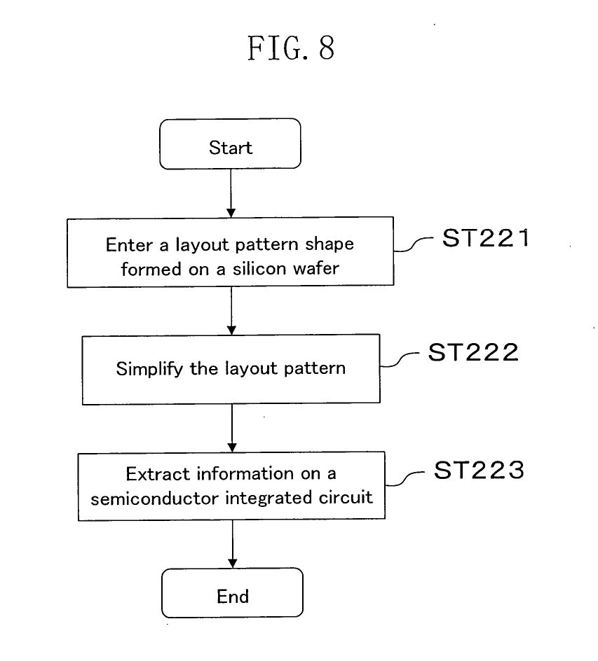

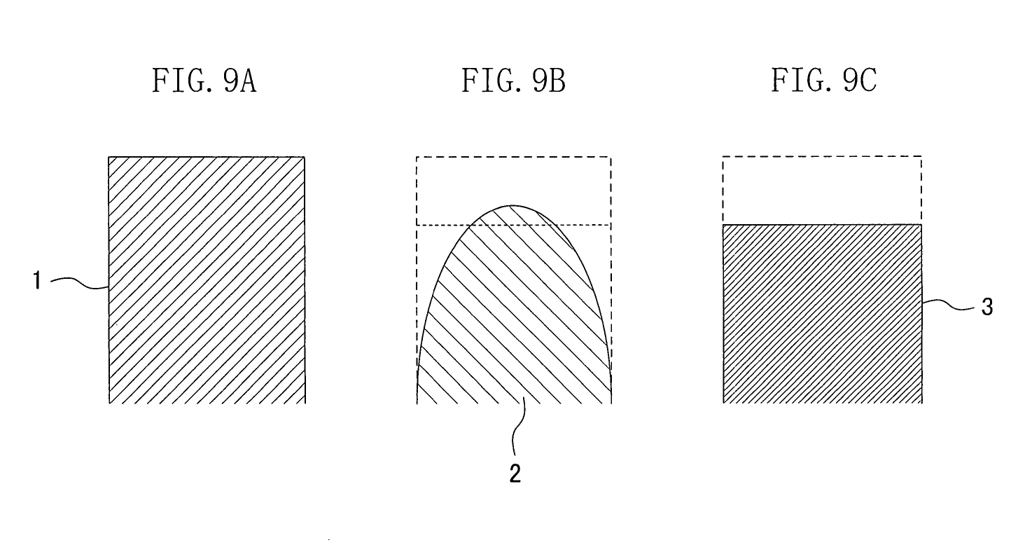

FIG. 8 shows a flow of processing performed in the circuit information extraction step ST220. In the circuit information extraction step ST220, the layout pattern shape formed on a silicon wafer is entered, and the layout pattern is simplified to facilitate extraction of circuit information (ST221 to ST222). FIGS. 9A to 9C show an example of the simplification. FIG. 9A shows original layout data (hatched region), and FIG. 9B shows a layout pattern shape (hatched region) formed on a silicon wafer. Specifically, FIG. 9B shows a layout pattern shape (hatched region) formed on a silicon wafer, represented by a curve or a polygon having a considerably large number of vertexes, which is to be simplified to a shape having roughly the same number of vertexes as the original layout data as preprocessing for extraction of information on a semiconductor integrated circuit.

In this simplification, the layout pattern shape formed on a silicon wafer is made to approximate the original layout data as shown in FIG. 9C (hatched region) by shifting sides of the layout pattern shape with reference to the sides of the polygon representing the original layout data.

Information on the semiconductor integrated circuit is then extracted from the simplified layout pattern (ST223). Examples of information extracted in this step include the gate length and gate width of transistor elements and the width of interconnections for connection between semiconductor elements. Based on such information, information on the semiconductor integrated circuit is reconstructed.

<Fault Point Detection Step ST230

In the fault point detection step ST230, circuit operation is simulated based on the information on the semiconductor integrated circuit, to locate a defective circuit.

### Embodiment 3

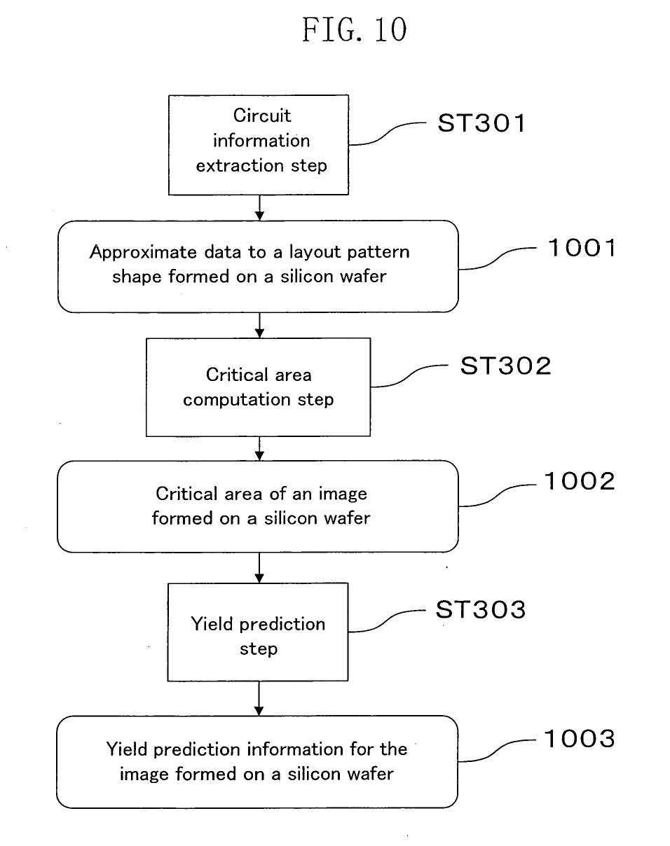

FIG. 10 is a flowchart showing a procedure of a mask pattern verification method of Embodiment 3 of the present invention. This method will be described with reference to FIG. 10.

Approximate data 1001 to the layout pattern shape formed on a silicon wafer, extracted in a circuit information extraction step ST301 (processing in this step is the same as that described in Embodiment 2) is given to a critical area computation step ST302.

In the critical area computation step ST302, the layout data 1001 is divided into line regions and space regions by graphic logical operation. The line regions are then classified into several types according to the line width by resizing and graphic logical operation, and the sum of critical areas for each type is determined. Likewise, the space regions are classified into several types according to the space shape, and the sum of critical areas for each type is determined. In this way, a critical area 1002 of an image formed on a silicon wafer is computed.

In a yield prediction step ST303, the yield of the image formed on a silicon wafer can be predicted from expression 1 to be described later, permitting random defect prediction for both open circuit and short circuit.

An example of prediction of the yield in fabrication will be described. Some methods have been proposed for yield prediction, including a method using a defect distribution curve and the critical area in which a defect actually causes a failure for the yield prediction (ISSM 1997, 0.25 um Integrated Circuit Yield Model Design and Validation).

The overall yield of a process is generally represented by the product of the systematic yield (YS) determined according to the system and the yield (YR) determined with a random defect.

The yield YR determined with a random defect is represented by the expression 1 below according to a Poisson distribution model, for example.
YR=exp(−DD*Ac) Expression 1
where DD is the number of defects per unit critical area and Ac is a critical area.

The critical area as used herein refers to the total sum of areas in a chip that may actually be impaired due to existence of defects.

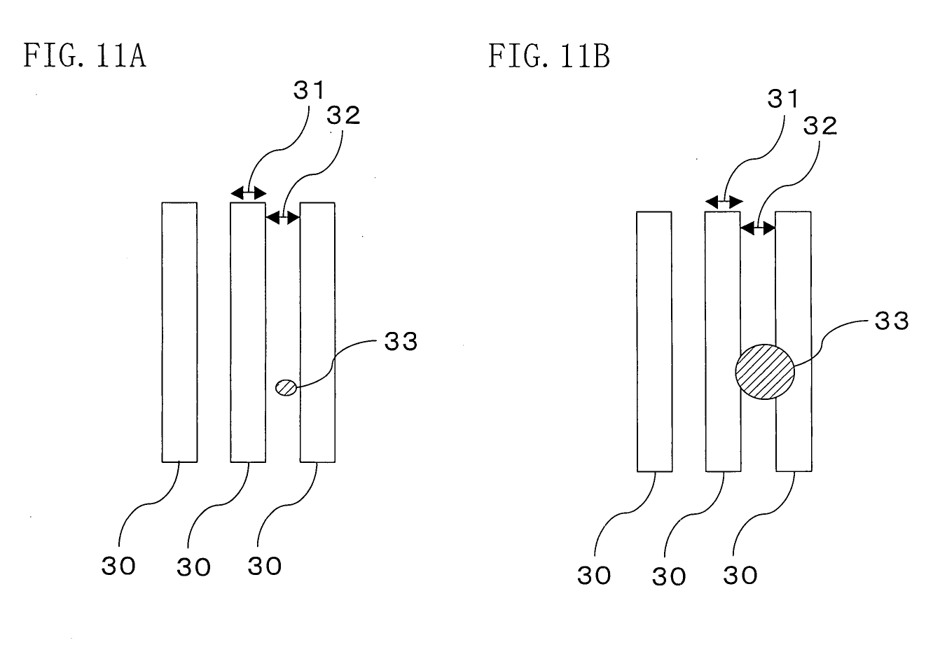

The idea of the critical area will be described in relation to a short circuit between interconnections with reference to FIGS. 11A and 11B. Assuming that interconnections 30 having a line width 31 run in parallel with each other with a space 32 therebetween, when a defect 33 is smaller than the space 32 as shown in FIG. 11A, the critical area is determined zero. When the defect 33 is greater than the space 32 as shown in FIG. 11B, the defect 33 may possibly cause a critical area. Therefore, by parameterizing the relationship among the line width 31, the space 32 and the defect 33, the critical area can be computed by extracting the layout data for each line width.

The critical area can also be computed in relation to open interconnections in a similar manner.

Thus, the yield prediction for the pattern formed on a silicon wafer can be performed by computing the critical area based on the data obtained after the extraction of the circuit information from the simulation result and adopting the model of the expression 1.

### Embodiment 4

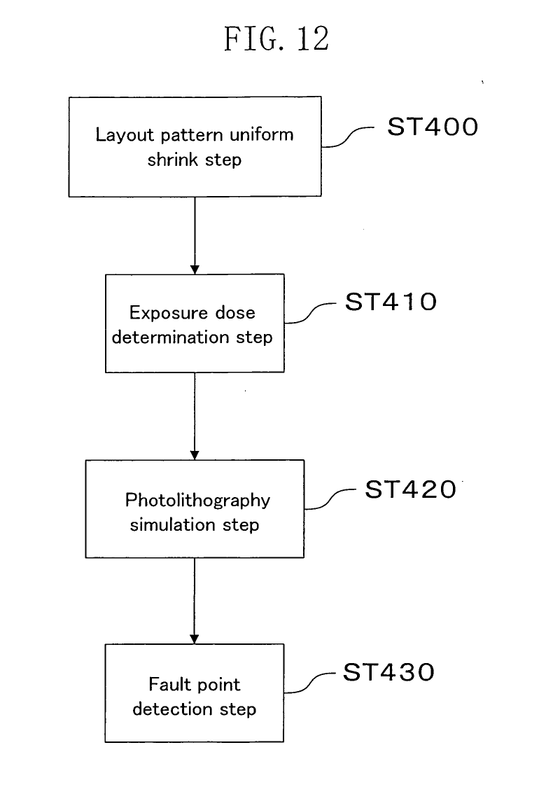

FIG. 12 is a flowchart showing a procedure of a circuit design verification method of Embodiment 4 of the present invention. This verification method is a circuit design verification method based on potential variation error performed using a layout pattern uniform shrink scheme. Hereinafter, steps of this method will be described specifically.

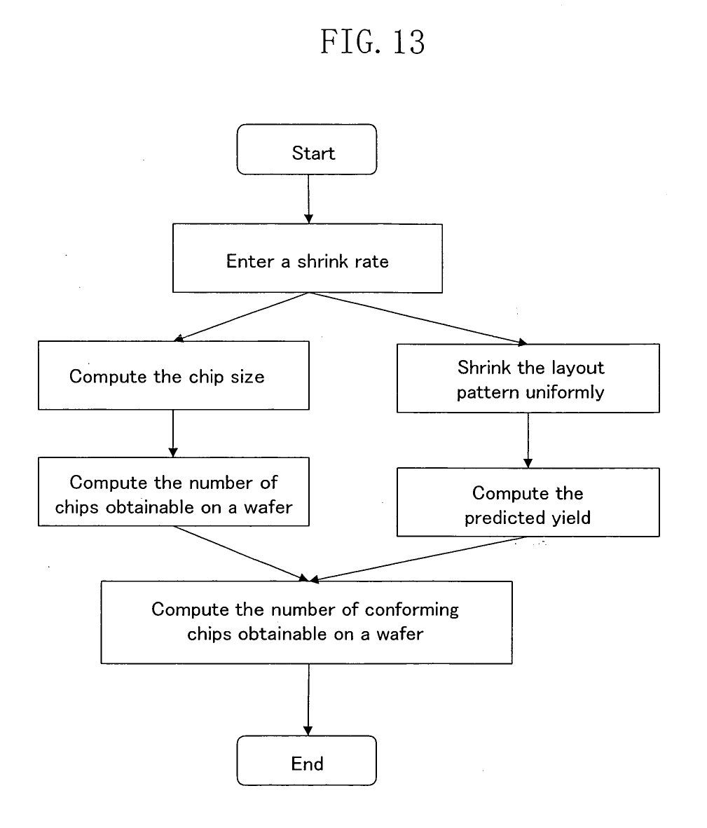

FIG. 13 shows a flow of processing performed in a layout pattern uniform shrink step ST400.

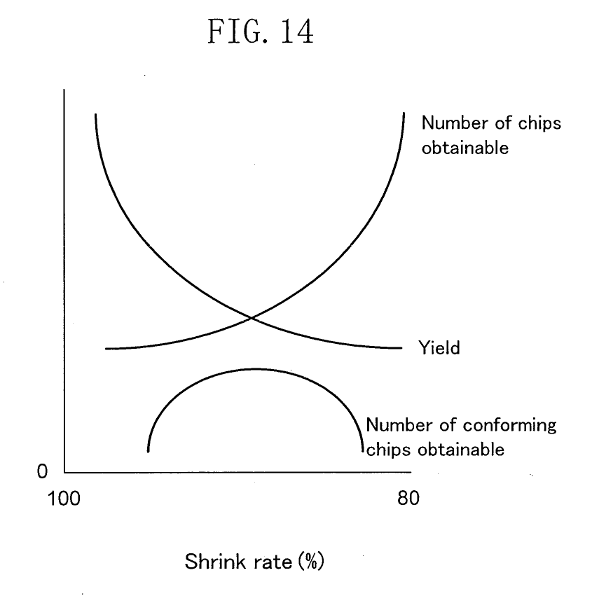

Referring to FIG. 13, in the layout pattern uniform shrink step ST400, the chip size after shrink is computed based on an entered shrink rate (ST401 to ST402), and the number of chips obtainable on a silicon wafer is computed from the chip size (ST403). Separately from this step, the layout pattern is uniformly shrunk (ST404), and the predicted yield for the shrunk data is computed (ST405). The number of conforming chips obtainable on a silicon wafer is then computed from the computation result of the number of chips obtainable on a silicon wafer and the computation result of the predicted yield (ST406). This computation of the number of conforming chips is made in the descending order of the shrink rate from 100%. As shown in FIG. 14, as the shrink rate decreases, the yield decreases, but the number of chips obtainable on a silicon wafer increases. By multiplying the yield by the number of chips obtainable on a silicon wafer, the number of conforming chips on a silicon wafer for each shrink rate can be computed, and from FIG. 14, the shrink rate at which the number of conforming chips is maximum can be determined.

In an exposure dose determination step ST410, the step width is determined according to the required analysis accuracy within the range of a variation in exposure dose arising in the fabrication process in fabrication of semiconductor integrated circuits, and the exposure dose is determined to be changed so that the range of the variation from its lower to upper limits is scanned with the step width.

In a photolithography simulation step ST420, simulation is performed to replicate the photolithography process in fabrication of semiconductor integrated circuits on a computer based on the exposure dose for each step width determined in the exposure dose determination step ST410. As a result of the simulation, a layout pattern shape formed on a silicon wafer is obtained.

In a fault point detection step ST430, circuit operation is simulated based on the information on the semiconductor integrated circuit, to locate a defective circuit.

While the present invention has been described in preferred embodiments, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

1. A mask pattern verification method as a verification method of extracting from a mask pattern a defect that is to cause a problem in fabrication, the mask pattern being one obtained by deforming a mask pattern of a photomask used in a photolithography process so as to provide a transferred image close to a desired design pattern, the verification method comprising the steps of:
a step (a) of determining the parameter in the photolithography process;
a step (b) of simulating the photolithography process on a computer based on the determined parameter;
a step (c) of checking whether or not the desired design pattern has been obtained; and
a step (d) of locating a fault point and outputting the result.

2. The mask pattern verification method of claim 1, wherein the exposure dose in the photolithography process is determined in the step (a), and
the photolithography process is simulated on a computer based on the determined exposure dose in the step (b).

3. The mask pattern verification method of claim 1, wherein the focal point in the photolithography process is determined in the step (a), and
the photolithography process is simulated on a computer based on the determined focal point in the step (b).

4. The mask pattern verification method of claim 1, wherein the exposure dose and the focal point in the photolithography process are determined in the step (a), and
the photolithography process is simulated on a computer based on the determined exposure dose and the determined focal point in the step (b).

5. The mask pattern verification method of claim 1, further comprising the step of:
a step (e) of simulating steps formed on a silicon wafer surface on a computer from a density distribution of a semiconductor circuit pattern on the silicon wafer surface,
wherein the exposure dose in the photolithography process is determined in the step (a), and
the photolithography process is simulated on a computer based on the simulated steps and the determined exposure dose in the step (b).

6. The mask pattern verification method of claim 1, further comprising the step of:
a step (e) of simulating steps formed on a silicon wafer surface on a computer from a density distribution of the semiconductor circuit pattern on the silicon wafer surface,
wherein the focal point in the photolithography process is determined in the step (a), and
the photolithography process is simulated on a computer based on the simulated steps and the determined focal point in the step (b).

7. The mask pattern verification method of claim 1, further comprising the step of:
a step (e) of simulating steps formed on a silicon wafer surface on a computer from a density distribution of a semiconductor circuit pattern on the silicon wafer surface,
wherein the exposure dose and the focal point in the photolithography process are determined in the step (a), and
the photolithography process is simulated on a computer based on the simulated steps, the determined exposure dose, and the determined focal point in the step (b).

8. The mask pattern verification method of claim 1, further comprising the steps of:
a step (f) of simulating a defect factor occurring with a given probability in fabrication on a computer; and
a step (g) of simulating the yield on a computer based on the simulation result of the photolithography process and the simulation result of the defect factor.

9. The mask pattern verification method of claim 8, further comprising the steps of:
a step (h) of extracting circuit information from a transferred image obtained from the result of the simulation; and
a step (i) of simulating circuit operation using the circuit information.

10. The mask pattern verification method of claim 1, further comprising the step of
a step (j) of shrinking the mask pattern uniformly,
wherein the photolithography process is simulated for the mask pattern shrunk in the step (j) on a computer based on the determined parameter in the step (b).

11. The mask pattern verification method of claim 10, further comprising the steps of:
a step (k) of simulating a defect factor occurring with a given probability in fabrication on a computer; and
a step (l) of simulating the yield on a computer based on the simulation result of the photolithography process and the simulation result of the defect factor.

12. The mask pattern verification method of claim 11, further comprising the steps of:
a step (m) of extracting circuit information from a transferred image obtained from the result of the simulation; and
a step (n) of simulating circuit operation using the circuit information.

13. A circuit information extraction method as a method for extracting circuit information that imitates a semiconductor integrated circuit in its operation, using a mask pattern obtained by deforming a mask pattern of a photomask used in a photolithography process so as to provide a transferred image close to a desired design pattern, the method comprising the steps of:
a step (a) of determining the parameter in the photolithography process;
a step (b) of simulating the photolithography process on a computer based on the determined parameter;
a step (c) of extracting circuit information from a transferred image obtained from the result of the simulation; and
a step (d) of locating a fault point and outputting the result.

14. The circuit information extraction method of claim 13, wherein the exposure dose in the photolithography process is determined in the step (a), and
the photolithography process is simulated on a computer based on the determined exposure dose in the step (b).

15. The circuit information extraction method of claim 13, wherein the focal point in the photolithography process is determined in the step (a), and
the photolithography process is simulated on a computer based on the determined focal point in the step (b).

16. The circuit information extraction method of claim 13, wherein the exposure dose and the focal point in the photolithography process are determined in the step (a), and
the photolithography process is simulated on a computer based on the determined exposure dose and the determined focal point in the step (b).

17. The circuit information extraction method of claim 13, further comprising the step of:
a step (e) of simulating steps formed on a silicon wafer surface on a computer from a density distribution of a semiconductor circuit pattern on the silicon wafer surface,
wherein the exposure dose in the photolithography process is determined in the step (a), and
the photolithography process is simulated on a computer based on the simulated steps and the determined exposure dose in the step (b).

18. The circuit information extraction method of claim 13, further comprising the step of:
a step (e) of simulating steps formed on a silicon wafer surface on a computer from a density distribution of a semiconductor circuit pattern on the silicon wafer surface,
wherein the focal point in the photolithography process is determined in the step (a), and
the photolithography process is simulated on a computer based on the simulated steps and the determined focal point in the step (b).

19. The circuit information extraction method of claim 13, further comprising the step of:
a step (e) of simulating steps formed on a silicon wafer surface on a computer from a density distribution of a semiconductor circuit pattern on the silicon wafer surface,
wherein the exposure dose and the focal point in the photolithography process are determined in the step (a), and
the photolithography process is simulated on a computer based on the simulated steps, the determined exposure dose, and the determined focal point in the step (b).

20. A circuit information extraction method as a method for extracting circuit information that imitates a semiconductor integrated circuit in its operation, the method comprising the steps of:
a step (a) of shrinking uniformly a mask pattern obtained by deforming a mask pattern of a photomask used in a photolithography process so as to provide a transferred image close to a desired design pattern;
a step (b) of determining the parameter in the photolithography process;
a step (c) of simulating the photolithography process for the mask pattern shrunk in the step (a) on a computer based on the determined parameter;
a step (d) of extracting circuit information from a transferred image obtained from the result of the simulation; and
a step (e) of locating a fault point and outputting the result.

21. The circuit information extraction method of claim 20, wherein the exposure dose in the photolithography process is determined in the step (b), and
the photolithography process is simulated for the mask pattern shrunk in the step (a) on a computer based on the determined exposure dose in the step (c).

22. The circuit information extraction method of claim 20, wherein the focal point in the photolithography process is determined in the step (b), and
the photolithography process is simulated for the mask pattern shrunk in the step (a) on a computer based on the determined focal point in the step (c).

23. The circuit information extraction method of claim 20, wherein the exposure dose and the focal point in the photolithography process are determined in the step (b), and
the photolithography process is simulated for the mask pattern shrunk in the step (a) on a computer based on the determined exposure dose and the determined focal point in the step (c).

24. The circuit information extraction method of claim 20, further comprising the step of:
a step (f) of simulating steps formed on a silicon wafer surface on a computer from a density distribution of a semiconductor circuit pattern on the silicon wafer surface,
wherein the exposure dose in the photolithography process is determined in the step (b), and
the photolithography process is simulated for the mask pattern shrunk in the step (a) on a computer based on the simulated steps and the determined exposure dose in the step (c).

25. The circuit information extraction method of claim 20, further comprising the step of:
a step (f) of simulating steps formed on a silicon wafer surface on a computer from a density distribution of a semiconductor circuit pattern on the silicon wafer surface,
wherein the focal point in the photolithography process is determined in the step (b), and
the photolithography process is simulated for the mask pattern shrunk in the step (a) on a computer based on the simulated steps and the determined focal point in the step (c).

26. The circuit information extraction method of claim 20, further comprising the step of:
a step (f) of simulating steps formed on a silicon wafer surface on a computer from a density distribution of a semiconductor circuit pattern on the silicon wafer surface,
wherein the exposure dose and the focal point in the photolithography process are determined in the step (b), and
the photolithography process is simulated for the mask pattern shrunk in the step (a) on a computer based on the simulated steps, the determined exposure dose, and the focal point in the step (c).

27. A parameter determination method as a method for determining for which region among regions on a silicon wafer a parameter in a photolithography process should be optimum when steps in the regions are different from each other, the method comprising the steps of:
holding the steps in the regions;
computing the average of the steps in the regions;
computing the variance of the steps in the regions; and
searching for an optimum parameter in the photolithography with which the number of defects is minimum based on the average of the steps in the regions and the variance of the steps in the regions.

28. The parameter determination method of claim 27, wherein the parameter in the photolithography process includes an exposure dose.

29. The parameter determination method of claim 27, wherein the parameter in the photolithography process includes a focal point.

30. The parameter determination method of claim 27, wherein the parameter in the photolithography process includes an exposure dose and a focal point.

31. A semiconductor device fabrication method, wherein a plurality of process management patterns are available in a semiconductor fabrication process, and
the process management pattern to be used is determined in advance based on the result of parameter simulation in a photolithography process.

32. The semiconductor device fabrication method of claim 31, wherein the process management pattern to be used is determined in advance based on the result of exposure dose simulation.

33. The semiconductor device fabrication method of claim 31, wherein the process management pattern to be used is determined in advance based on the result of defocus simulation.

34. The semiconductor device fabrication method of claim 31, wherein the process management pattern to be used is determined in advance based on the integrated results of step simulation, exposure dose simulation, and defocus simulation.

35. A mask pattern verification method as a verification method of extracting from a mask pattern a defect that is to cause a problem in fabrication, the mask pattern being one obtained by deforming a mask pattern of a photomask used in a photolithography process so as to provide a transferred image close to a desired design pattern, the verification method comprising the steps of:
simulating steps formed on a silicon wafer surface on a computer from a density distribution of a semiconductor circuit pattern on the silicon wafer surface;
holding values of the steps computed by the simulation as discrete values according to the density distribution of the semiconductor circuit pattern in the form of a table;
converting the values of the steps to size shift values of a semiconductor circuit pattern formed on a silicon wafer;
forming a semiconductor circuit pattern image from the result of the size conversion;
extracting circuit information from the semiconductor circuit pattern image; and
locating a fault point and outputting the result.

36. The mask pattern verification method of claim 35, further comprising the step of:
simulating the yield on a computer based on the simulation result of the circuit operation.

37. A mask pattern verification method as a verification method of extracting from a mask pattern a defect that is to cause a problem in fabrication, the mask pattern being one obtained by deforming a mask pattern of a photomask used in a photolithography process so as to provide a transferred image close to a desired design pattern, the verification method comprising the steps of:
simulating steps formed on a silicon wafer surface on a computer from a density distribution of a semiconductor circuit pattern on the silicon wafer surface;
holding values of the steps computed by the simulation as discrete values according to the density distribution of the semiconductor circuit pattern in the form of a table;
converting the values of the steps to size shift values of a semiconductor circuit pattern formed on a silicon wafer;
forming a semiconductor circuit pattern image from the result of the size conversion;
simulating a defect factor occurring with a given probability in fabrication on a computer;
simulating the yield on a computer based on the semiconductor circuit pattern image and the simulation result of the defect factor; and
locating a fault point and outputting the result.

38. A mask pattern verification method as a verification method of extracting from a mask pattern a defect that is to cause a problem in fabrication, the mask pattern being one obtained by deforming a mask pattern of a photomask used in a photolithography process so as to provide a transferred image close to a desired design pattern, the verification method comprising the steps of:
shrinking the mask pattern uniformly to form a semiconductor circuit pattern image; and
extracting circuit information from the semiconductor circuit pattern image.

39. The mask pattern verification method of claim 38, further comprising the steps of:
simulating a defect factor occurring with a given probability in fabrication on a computer;
simulating the yield on a computer based on the semiconductor circuit pattern image and the simulation result of the defect factor; and
locating a fault point and outputting the result

40. A mask pattern verification method as a verification method of extracting from a mask pattern a defect that is to cause a problem in fabrication, the mask pattern being one obtained by deforming a mask pattern of a photomask used in a photolithography process so as to provide a transferred image close to a desired design pattern, the verification method comprising the steps of:
simulating steps formed on a silicon wafer surface on a computer from a density distribution of a semiconductor circuit pattern on the silicon wafer surface;
holding values of the steps computed by the simulation as discrete values according to the density distribution of the semiconductor circuit pattern in the form of a table;
converting the values of the steps to size shift values of a semiconductor circuit pattern formed on a silicon wafer;
forming a first semiconductor circuit pattern image from the result of the size conversion;
shrinking the first semiconductor circuit pattern image uniformly to form a second semiconductor circuit pattern image;
extracting circuit information from the second semiconductor circuit pattern image;
simulating circuit operation using the circuit information; and
locating a fault point and outputting the result.

41. A mask pattern verification method as a verification method of extracting from a mask pattern a defect that is to cause a problem in fabrication, the mask pattern being one obtained by deforming a mask pattern of a photomask used in a photolithography process so as to provide a transferred image close to a desired design pattern, the verification method comprising the steps of:
simulating steps formed on a silicon wafer surface on a computer from a density distribution of a semiconductor circuit pattern on the silicon wafer surface;
holding values of the steps computed by the simulation as discrete values according to the density distribution of the semiconductor circuit pattern in the form of a table;
converting the values of the steps to size shift values of a semiconductor circuit pattern formed on a silicon wafer;
forming a first semiconductor circuit pattern image from the result of the size conversion;
shrinking the first semiconductor circuit pattern image uniformly to form a second semiconductor circuit pattern image;
simulating a defect factor occurring with a given probability in fabrication on a computer;
simulating the yield on a computer based on the second semiconductor circuit pattern image and the simulation result of the defect factor; and
locating a fault point and outputting the result.

42. A mask pattern verification method as a verification method of extracting from a mask pattern a defect that is to cause a problem in fabrication, the mask pattern being one obtained by deforming a mask pattern of a photomask used in a photolithography process so as to provide a transferred image close to a desired design pattern, the verification method comprising the steps of:
shrinking the mask pattern uniformly to form a semiconductor circuit pattern image;
extracting circuit information from the semiconductor circuit pattern image;
simulating circuit operation using the circuit information;
simulating the yield on a computer based on the simulation result of the circuit operation; and
locating a fault point and outputting the result.

43. A mask pattern verification method as a verification method of extracting from a mask pattern a defect that is to cause a problem in fabrication, the mask pattern being one obtained by deforming a mask pattern of a photomask used in a photolithography process so as to provide a transferred image close to a desired design pattern, the verification method comprising the steps of:
simulating steps formed on a silicon wafer surface on a computer from a density distribution of a semiconductor circuit pattern on the silicon wafer surface;
holding values of the steps computed by the simulation as discrete values according to the density distribution of the semiconductor circuit pattern in the form of a table;
converting the values of the steps to size shift values of a semiconductor circuit pattern formed on a silicon wafer;
forming a first semiconductor circuit pattern image from the result of the size conversion;
shrinking the first semiconductor circuit pattern image uniformly to form a second semiconductor circuit pattern image;
extracting circuit information from the second semiconductor circuit pattern image;
simulating circuit operation using the circuit information;
simulating the yield on a computer based on the simulation result of the circuit operation; and
locating a fault point and outputting the result.
